(19) United States
(12) Patent Application Publication
(10) Pub. No.: US 2025/0172168 A1
(43) Pub. Date: May 29, 2025

(54) SCREW

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); CHEN-LONG SU, KAOHSIUNG CITY (TW)

(21) Appl. No.: 18/523,009

(22) Filed: Nov. 29, 2023

(51) Int. Cl. F16B 25/10; F16B 25/00

(52) U.S. Cl. CPC F16B 25/103; F16B 25/0052; F16B 25/0084

(57) ABSTRACT

A screw includes a head, a shank, a thread unit, and a drill portion. The drill portion includes a drill body with an end portion and opposite groove regions and opposite drilling regions respectively formed on the drill body. Regarding each drilling region, on one side of each groove region is formed a cutting unit which has a connecting section extending outwards from the groove region and a cutting edge section connected to the connecting section, and on the other side of the groove region is mainly formed a first join wall which has a slanted surface so that the drill body narrows gradually towards the end portion. A first distance defined between two junctions where respective connecting sections meet respective cutting edge sections is greater than an outer diameter of the shank. Accordingly, the screw reams, cuts quickly, removes chips, and attains a stable fastening effect.

### BACKGROUND OF THE INVENTION

### 1. Field of the Invention

This invention relates to a screw and relates particularly to a screw having a special drilling configuration.

### 2. Description of the Related Art

Referring to FIG. 1, a conventional screw 1 includes a shank 11, a head 12 connected to the shank 11, and a plurality of threads 13 spiraling around the shank 11. The shank 11 tapers to form a tip 14 opposite to the head 12 and has at least one groove 15 formed thereon. In operation, the head 12 is rotated to drill the shank 12 and the threads 13 into a workpiece, such as wood (not shown). The groove 15 serves to cut the workpiece and accommodate chips caused by cutting, thereby completing a screwing operation. However, the cutting effect of the groove 15 is usually limited, so fibers cannot be efficiently severed. The groove 15 also fails to help quick removal of the chips and has a limited area for receiving residual chips. Thus, the accumulation of the chips blocks the groove 15 easily and causes larger resistance against the screwing operation. The excessive accumulation of the chips also adds undue pressure to the workpiece, which causes the workpiece to crack easily. Thus, the screw 1 needs to be improved.

### SUMMARY OF THE INVENTION

An object of this invention is to provide a screw capable of reaming, reducing drilling resistance for a quick drilling operation, and attaining a stable fastening effect.

A screw of this invention is as defined in claim 1 and includes a head, a shank extending longitudinally from the head, a thread unit spirally disposed on the shank, and a drill portion connected to the shank. The shank defines a central axis. The drill portion includes a drill body connected to the shank, two opposite groove regions recessed into the drill body, and two opposite drilling regions formed on the drill body. The drill body has an end portion located in opposing relationship to the shank. Each groove region includes at least one groove wall. Each drilling region includes a cutting unit formed on a first side of one groove region, a first join wall connected to a second side of the groove region, and a second join wall formed between the first join wall and the other groove region. The cutting unit includes a connecting section extending outwards from the first side of the groove region and a cutting edge section connected to the connecting section and extending inclinedly in an extension direction opposite to the shank. One cutting edge section of one cutting unit and the other cutting edge section of the other cutting unit converge at the end portion. The connecting section and the cutting edge section of the cutting unit converge at one junction, and the other connecting section and the other cutting edge section of the other cutting unit converge at the other junction. A first distance is defined from the junction to the other junction. The first distance is greater than the outer diameter of the shank. The first join wall has a slanted surface inclined to the central axis, thereby allowing a thickness of the drill body to be gradually reduced towards the end portion when viewed from the cutting edge section.

In accordance with the above arrangement, the larger first diameter defined by the outward extensions of the opposite cutting units coexists with the gradually-reduced thickness to help enlarge a drilled hole while drilling and subject a workpiece to an efficient cutting operation so that the drill portion is quickly drilled into the workpiece. The above conditions also provide an area sufficient to receive and move chips caused by the cutting operation.

Accordingly, the quick cutting effect and quick removal of chips can be attained. The thread unit continues the cutting operation so that the thread unit can be engaged with the workpiece. According to the claimed configuration, a stable fastening effect can be attained to prevent the screw from getting loose easily.

Preferably, each groove region can include two groove walls. For example, each groove region includes a first groove wall joined to an outer periphery of the drill body and a second groove wall connected to the first groove wall. Accordingly, each connecting section of the cutting unit, preferably curved in shape, extends outwards from each first groove wall, and each first join wall is connected to each second groove wall.

Preferably, the cutting edge section can include a cutting edge extending inclinedly and a trailing wall joined to the cutting edge. In particular, each trailing wall extends backwards from a cutting edge corresponding to the trailing wall. That is, the trailing wall extends in a direction opposite to the groove region related to the corresponding cutting edge. One cutting edge of one cutting unit and the other cutting edge of the other cutting unit converge at the end portion.

Preferably, the second join wall can be inclined to the central axis, and the thread unit can be connected to one of the groove regions, thereby removing chips and increasing the strength of the screw structure.

Preferably, a plurality of curved recesses can be formed on an underside of the head, and a connecting edge can be formed between two adjacent recesses, thereby achieving a close combination between the head and the workpiece.

Preferably, an auxiliary portion can be spirally disposed on the shank and located between the thread unit and the head, and a spiral angle defined by the auxiliary portion can be different from a spiral angle defined by the thread unit to continue the cutting operation.

The thread unit includes a plurality of threads spirally winding around the outer periphery of the shank. Preferably, a plurality of ribs can be located between the threads and formed by protruding outwards from the outer periphery of the shank. It is also possible to form a plurality of notches on the threads. Accordingly, the ribs, the notches, or the coexistence of the ribs and the notches can assist the thread unit in cutting to attain an auxiliary cutting effect.

### BRIEF DESCRIPTION OF THE DRAWINGS

FIG. 1 is a schematic view showing a conventional screw;

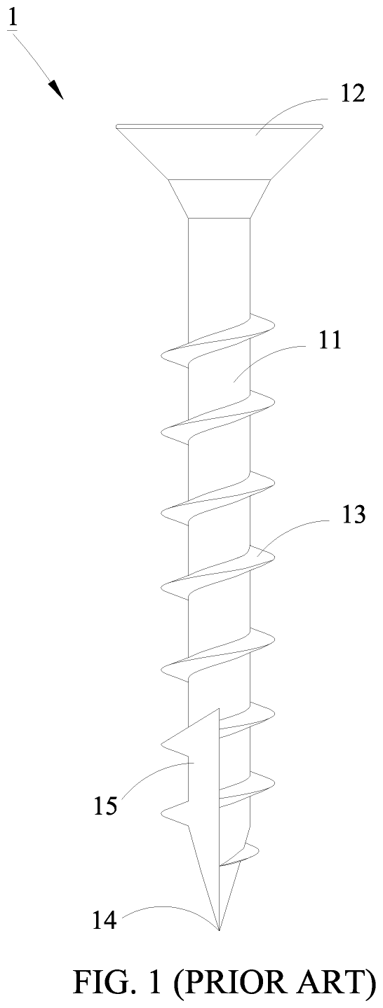

FIG. 2 is a perspective view showing a first preferred embodiment of this invention;

FIG. 2A is an enlarged view showing an encircled portion X1 of FIG. 2;

FIG. 3 is a front elevational view of FIG. 2;

FIG. 3A is an enlarged view showing an encircled portion X2 of FIG. 3;

FIG. 4 is a right side view of FIG. 2;

FIG. 4A is an enlarged view showing an encircled portion X3 of FIG. 4;

FIG. 5 is a bottom plan view of FIG. 2;

FIG. 6 is a schematic view showing the first preferred embodiment in use; and

FIG. 7 is a partial schematic view showing the first preferred embodiment in use.

### DETAILED DESCRIPTION OF THE PREFERRED EMBODIMENTS

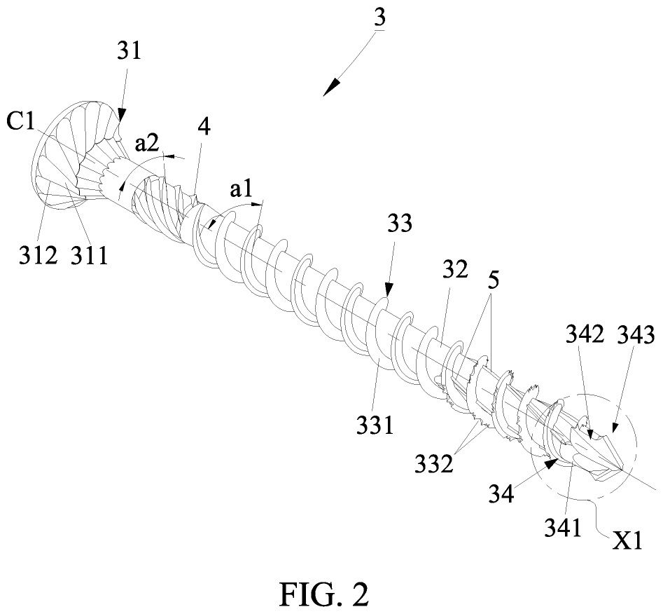

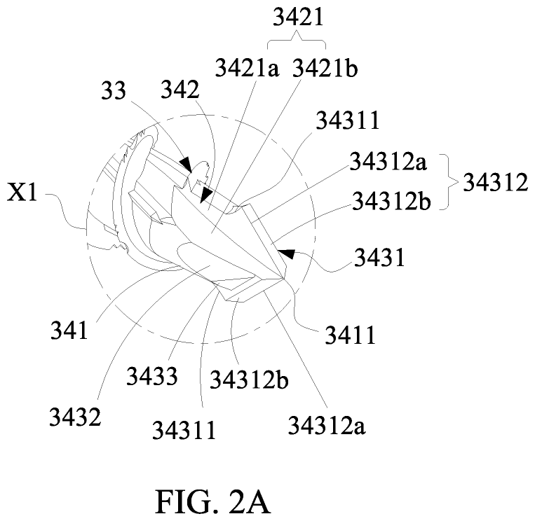

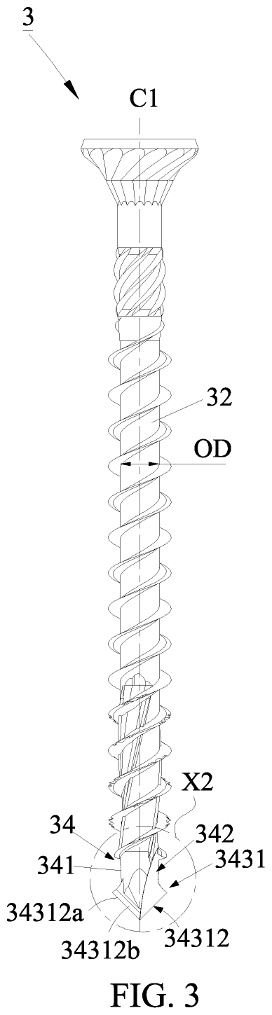

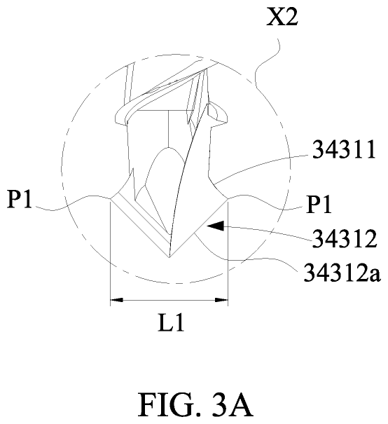

Referring to FIG. 2 and FIG. 3, a first preferred embodiment of the screw 3 is shown. The screw 3 includes a head 31, a shank 32 extending longitudinally from the head 31, a thread unit 33 spirally disposed on the shank 32, and a drill portion 34 connected to the shank 32. Specifically, the appearance of the head 31 is adjustable to meet demand. For example, a plurality of recesses 311 can be formed on a bottom surface of the head 31, and a connecting edge 312 can be formed between two adjacent recesses 311. The recess 311 can have an inward curved surface whereby the recess 311 is curved in shape. The recesses 311 and the connecting edges 312 assist the head 31 in being closely engaged with a workpiece 6. Furthermore, the shank 32 extends axially from the head 31 and defines a central axis C1. An outer periphery of the shank 32 also defines an outer diameter OD. An auxiliary thread 4 can be properly disposed on the shank 32 and located between the thread unit 33 and the head 31. A helical angle a2 defined by the auxiliary thread 4 is different from a spiral angle a1 of any thread 331 of the thread unit 33, so the auxiliary thread 4 follows the thread unit 33 and continues the cutting action for further drilling.

Furthermore, the thread unit 33 includes a plurality of threads 331 spirally disposed around the outer periphery of the shank 32. In this preferred embodiment, located between the threads 331 can be formed a plurality of ribs 5 which protrude outwards from the outer periphery of the shank 32. It is also possible that a plurality of notches 332 can be formed on the threads 331. The ribs 5 and the notches 332 serve to assist the thread unit 33 in cutting, thereby attaining an auxiliary cutting effect.

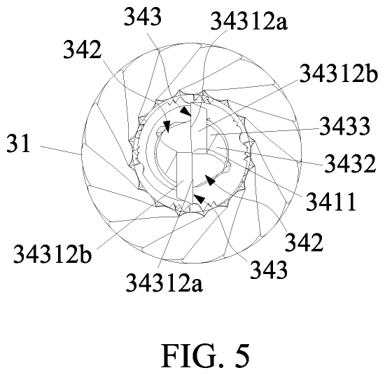

The drill portion 34 includes a drill body 341, two groove regions 342, and two drilling regions 343. Referring to FIG. 2A and FIG. 5, the drill body 341 is connected to the shank 32. Explicitly, the drill body 341 extends outwards from the shank 32 and includes an end portion 3411 located in opposing relationship to the shank 32. Two opposite groove regions 342 are recessedly formed. In other words, the groove regions 342 are recessed into the drill body 341. Each groove region 342 has at least one groove wall 3421. Accordingly, the groove region 342 serves as an accommodation area enclosed by at least one groove wall 3421; that is, a single groove wall 3421 or more than one groove wall 3421.

In this preferred embodiment, two groove walls 3421 are adopted as an example. Specifically, each groove region 342 can include a first groove wall 3421a joined to an outer periphery of the drill body 341 and a second groove wall 3421b connected to the first groove wall 3421a. The thread unit 33 can be connected to the groove region 342, and preferably one end of the thread unit 33 can be connected to at least one groove wall 3421 of one of the groove regions 342. According to FIG. 2A where two groove walls 3421 are shown, one end of the thread unit 33 can be connected to the first groove wall 3421a of one groove region 342, thereby accommodating chips, guiding and removing chips, and preventing the undue accumulation of the chips.

Two opposite drilling regions 343 are formed on the drill body 341. Each drilling region 343 includes a cutting unit 3431 and a first join wall 3432 respectively formed on two sides of one groove region 342. That is, the cutting unit 3431 is formed on a first side of the groove region 342, and the first join wall 3432 is connected to a second side of the groove region 342. The drilling region 343 also includes a second join wall 3433 connected to the first join wall 3432. Furthermore, the cutting unit 3431 includes a connecting section 34311 extending outwards from the first side of the groove region 342. In this preferred embodiment, when the groove region 342 has two groove walls 3421, the first side is defined by the first groove wall 3421a, and the second side is defined by the second groove wall 3421b. Accordingly, the connecting section 34311 is formed in a protruding manner. In other words, the connecting section 34311 extends outwards from the first groove wall 3421a, and it is also possible that the first join wall 3432 is connected to the second groove wall 3421b. According to this arrangement, the second join wall 3433 can be formed between the first join wall 3432 and the other groove region 342, as for example shown in the figures that a second join wall 3433 of one drilling region 343 is formed between a first join wall 3432 to which the second join wall 3433 is connected and the other cutting unit 3431 of the other drilling region 343.

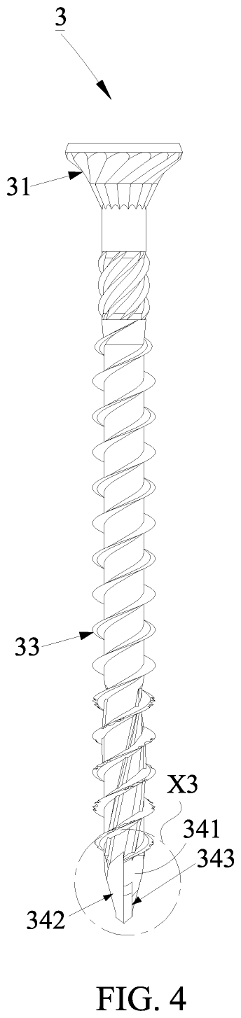

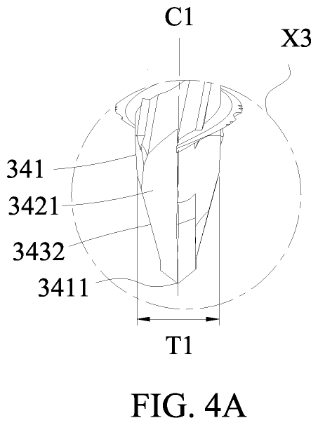

In this preferred embodiment, the connecting section 3433 can be, but not limited to, curved in shape (shown in FIG. 3 and FIG. 3A where an inward curved contour is shown), and the second join wall 3433 can have a slanted surface inclined to the central axis C1. The above conditions help increase the strength of the screw structure. Furthermore, the first join wall 3432 has a slanted surface inclined to the central axis C1, and therefore the thickness T1 of the drill body 341, shown in the side view illustrated by FIG. 4 and FIG. 4A, is gradually reduced in the direction of the end portion 3411 when viewed from the cutting edge section 34312 which will be described as follows. That is, the drill body 341 narrows gradually from the shank 32 towards the end portion 3411.

The cutting unit 3431 also includes a cutting edge section 34312 connected to the connecting section 34311. The cutting edge section 34312 extends in an inclined manner, so the cutting edge section 34312 extends in an inclination direction opposite to the shank 32. Accordingly, regarding the two drilling regions 343, the end portion 3411 is a place where the cutting edge section 34312 of one cutting unit 3431 and the other cutting edge section 34312 of the other cutting unit 3431 meet. In this preferred embodiment, the cutting edge section 34312 can include a cutting edge 34312a extending inclinedly in the extension direction, which allows the cutting edge 34312a of one cutting edge section 34312 and the other cutting edge 34312a of the other cutting unit 34312 to converge at the end portion 3411 so that the end portion 3411 serves as a drilling tip.

The cutting edge section 34312 also includes a trailing wall 34312b joined to the cutting edge 34312a. The trailing wall 34312b extends in a direction opposite to the groove region 342. That is, the trailing wall 34312b is a wall extending backwards from a corresponding cutting edge 34312a to which the trailing wall 34312b is joined, as shown in FIG. 4 and FIG. 5. Overall, the trailing wall 34312b of one drilling region 343 is formed between the corresponding cutting edge 34312a of the drilling region 343 and the other second join wall 3433 of the other drilling region 343. Preferably, the trailing wall 34312b can be inclined to the central axis C1 to strengthen the structure of the corresponding cutting edge 34312a, thereby increasing the cutting strength of each drilling region 343.

Referring to the front elevational view illustrated by FIG. 3 and FIG. 3A, the connecting section 34311 of one cutting unit 3431 and the cutting edge section 34312 thereof converge at one junction P1. The junction P1 can be a point where the connecting section 34311 and the cutting edge section 34312 meet. The other connecting section 34311 of the other cutting unit 3431 and the other cutting edge section 34312 thereof converge at the other junction P1. A length between the two junctions P1 is defined as a first distance L1. The first distance L1 is greater than the outer diameter OD of the shank 32. Overall, the maximum width of the drilling region 343, namely the first distance L1, is larger than the outer diameter of the shank 32, and the width of the drilling region 343 is gradually reduced towards the end portion 3411. Consequently, the drill portion 34 as a whole presents a structure which is wide in the front view and narrow in the side view because of the coexistence of the first distance L1 and the inclination of the first join wall 3432.

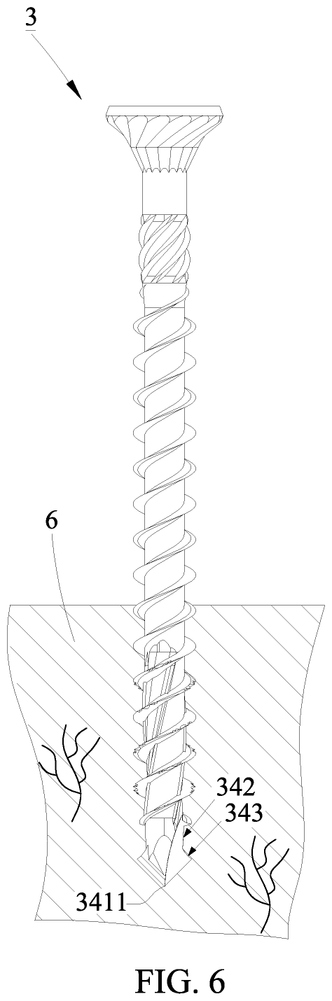

The operation of this invention is described with the aid of FIGS. 2 to 6. The screw 3 is adapted to be drilled into a workpiece 6 made of iron, wood, etc., and herein the workpiece 6 made of wood is taken as an example. In use, the end portion 3411 is put against a surface of the workpiece 6, and then the head 31 is rotated to execute a drilling operation. At the beginning of the drilling operation, internal fibers of the workpiece 6 are cut by two cutting edge sections 34312. Explicitly, the cutting edges 34312a cooperate with the groove regions 342 to carry out a cutting action whereby the fibers are cut and severed, with the result that the cutting action reduces the friction between the workpiece 6 and the drill portion 34. During the process of cutting the fibers, a drilled hole is formed in the workpiece 6. The first distance L1 defined by the outward extensions of the cutting units 3431 of the drilling regions 343 can help enlarge a hole diameter of the drilled hole for attaining a reaming effect. Meanwhile, the gradually-reduced thickness T1 caused by the two slanted first join walls 3432 not only allows the drilling regions 343 and the groove regions 342 to be easily drilled into the drilled hole but also provides an area sufficient to accommodate adequate chips cut by the cutting action. Accordingly, the drill body 341 can be quickly driven and drilled into the workpiece 6, and therefore the drill portion 34 can be stably engaged with the workpiece 6 during the initial drilling operation.

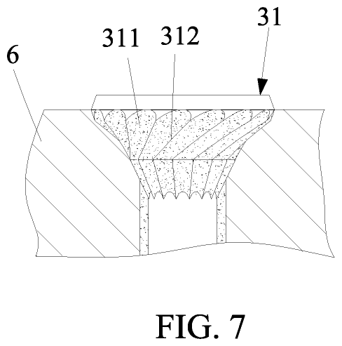

During the drilling operation of the drill portion 34, chips are generated while cutting the fibers with the cutting edge sections 34312 and the groove regions 342. At this moment, the coexistence of the first distance L1 and the accommodation areas respectively enclosed by the groove regions 342 serve to receive the chips and help removal of the chips, thereby preventing the cracking problem of the workpiece 6 caused by undue accumulation and outward pushing force of the chips. In other words, the workpiece 6 does not crack easily. Then, because the thread unit 33 is connected to the groove region 342, the thread unit 33 enters the workpiece 6 directly by following a spiral track created by the drilling of the drilling regions 343. Thus, the drilling resistance can be efficiently reduced. Meanwhile, the thread unit 33 is engaged with the workpiece 6 and keeps drilling into the workpiece 6 by cutting. In addition, the chips enter the groove regions 342, then go into the shank 32, and thence move along a spiral direction of the thread unit 33. Finally, multiple chips are pushed out of the head 31, thereby attaining the removal of chips. Furthermore, the recesses 311 and the connecting edges 312 function to scrape off burrs accumulated around an exit of the drilled hole, which not only prevents the burrs from breaking the combination between the head 31 and the workpiece 6 but also provides a larger area for accommodating adequate chips, as shown in FIG. 7. According to the combination of the above correlated elements, the screw 3 increases the drilling efficiency, attains the quick removal of chips, and prevents the workpiece 6 from cracking. A stable fastening effect is achieved by receiving sufficient chips so that the screw 3 does not get loose easily. Therefore, an anti-loosening effect is also achieved.

To sum up, this invention takes advantage of outward extensions of the opposite cutting units and the gradually-reduced thickness caused by inclined first join walls to allow the drill portion as a whole to present a strengthened structure which is not only wide but also narrow. Consequently, the drill portion assists the screw in reaming for attaining a quick drilling effect, subjects a workpiece to a quick cutting operation, and accommodates and removes chips efficiently, thereby attaining a stable fastening effect and an anti-loosening effect.

While the embodiments are shown and described above, it is understood that further variations and modifications may be made without departing from the scope of this invention.

What is claimed is:

1. A screw comprising:
a head;
a shank extending longitudinally from said head and defining a central axis, wherein an outer periphery of said shank defines an outer diameter;
a thread unit spirally disposed on said shank; and
a drill portion connected to said shank, wherein said drill portion includes a drill body connected to said shank, two opposite groove regions recessed into said drill body, and two opposite drilling regions formed on said drill body, said drill body including an end portion located in opposing relationship to said shank, each of said groove regions including at least one groove wall, each of said drilling regions including a cutting unit formed on a first side of one of said groove regions, a first join wall connected to a second side of said one groove region, and a second join wall formed between said first join wall and another one of said groove regions, said cutting unit including a connecting section extending outwards from said first side of said one groove region and a cutting edge section connected to said connecting section and extending inclinedly in an extension direction opposite to said shank, with said cutting edge section of one cutting unit and another cutting edge section of another cutting unit converging at said end portion, said connecting section and said cutting edge section of said one cutting unit converging at one junction, another connecting section and said other cutting edge section of said other cutting unit converging at another junction, a first distance being defined from said one junction to said other junction, said first distance being greater than said outer diameter of said shank, each said first join wall having a slanted surface inclined to said central axis, and a thickness of said drill body thereby being gradually reduced towards said end portion when viewed from said cutting edge section.

2. The screw according to claim 1, wherein each of said groove regions includes a first groove wall joined to an outer periphery of said drill body and a second groove wall connected to said first groove wall, with said first side defined by said first groove wall, said second side defined by said second groove wall, said connecting section of said cutting unit extending outwards from said first groove wall, and said first join wall being connected to said second groove wall.

3. The screw according to claim 1, wherein said connecting section is curved in shape.

4. The screw according to claim 1, wherein said cutting edge section including a cutting edge extending inclinedly in said extension direction and a trailing wall joined to said cutting edge and extending in a direction opposite to said one groove region, with said cutting edge of said cutting edge section and another cutting edge of said other cutting edge section converging at said end portion.

5. The screw according to claim 1, wherein said second join wall is inclined to said central axis.

6. The screw according to claim 1, wherein said thread unit is connected to said one groove region.

7. The screw according to claim 1, wherein a plurality of curved recesses are formed on an underside of said head, a connecting edge being formed between two adjacent recesses.

8. The screw according to claim 1, wherein an auxiliary portion is spirally disposed on said shank and located between said thread unit and said head, a spiral angle defined by said auxiliary portion being different from a spiral angle defined by said thread unit.

9. The screw according to claim 1, wherein said thread unit includes a plurality of threads spirally winding around said outer periphery of said shank, a plurality of ribs being located between said threads and formed by protruding outwards from said outer periphery of said shank.

10. The screw according to claim 1, wherein said thread unit includes a plurality of threads spirally winding around said outer periphery of said shank, a plurality of notches being formed on said threads.
